(19) United States
(12) Patent Application Publication
(10) Pub. No.: US 2011/0135235 A1
(43) Pub. Date: Jun. 9, 2011

(54) BALL BEARING FOR A TURBOCHARGER

(75) Inventor: Aaron CHRISS, WOODBURY, CT (US)

(73) Assignee: SCHAEFFLER TECHNOLOGIES GMBH & CO. KG, HERZOGENAURACH (DE)

(21) Appl. No.: 12/959,836

(22) Filed: Dec. 3, 2010

Related U.S. Application Data
(60) Provisional application No. 61/266,557, filed on Dec. 4, 2009.

(51) Int. Cl. F16C 33/38

(52) U.S. Cl. 384/523

(57) ABSTRACT

A ball bearing arrangement for a turbocharger. This ball bearing arrangement has a turbocharger shaft, which is to be mounted, and a housing part of the turbocharger. An inner raceway of the ball bearing arrangement is formed on an outer surface of the turbocharger shaft, an outer raceway of the ball bearing arrangement is formed on an inner surface of the housing part, and balls are inserted between the outer raceway and the inner raceway. The inner raceway and/or the outer raceway are/is fabricated from an M62 steel.

### FIELD OF THE INVENTION

The invention lies in the field of high-power roller bearings in turbochargers.

DE 11 2004 002 481 T5 discloses such a turbocharger with a high-performance roller bearing, an angular ball bearing. This turbocharger has a turbine wheel which drives a compressor wheel of the turbocharger via a rotatably mounted shaft. According to DE 11 2004 002 481 T5, this shaft which rotates at high speed is mounted by means of two angular ball bearings which support the shaft with respect to a fixed housing.

Ball bearings, for example angular ball bearings or deep groove ball bearings, are sufficiently known and generally have an inner ring, an outer ring and roller bodies or balls which are arranged between the inner ring and the outer ring in a circumferential direction. The balls are held at a distance distributed uniformly over the circumference using a ball bearing cage.

Ball bearing cages of various designs, for example sheet-metal cages or solid cages, made of various materials, for example sheet steel, brass, light metal, sintering iron, fabric-base laminate, and with different designs, for example window cages, snap-type cages or a riveted cage, are also known.

In particular in the case of ball bearings of shafts which rotate at high speed, such as for example turbocharger shafts, instabilities and vibrations occur, i.e. the cages and roller bodies of such ball bearings which rotate at high speed are excited, which leads to juddering, vibrations and/or erratic or chaotic movements of the cage and of the roller bodies.

Furthermore, it has been observed that in particular in the case of turbocharger shafts, changing axial loads occur, which leads in turn to erratic or chaotic movements of the roller bodies of bearings which are used there. In addition, tilting movements of turbocharger shafts lead to a situation in which the roller bodies follow elliptical paths, which subsequently leads to massive deflections and spin of the roller bodies or in the roller bodies.

All these effects lead in turn to shock-like loading on run-up faces and/or raceways. Subsequent to this, these effects can lead—when present to the above-average degree observed in turbochargers—to overheating of the ball bearing, decomposition of the lubricant or even to destruction of the ball bearing. Such instabilities are usually also accompanied by increased, abnormal bearing noises.

Furthermore, investigations have shown that abrasive wear occurs in such bearings during the running in or else in a later phase of the operation of a turbocharger, and this leads to an increased occurrence of bearing damage and bearing failures. External influences such as soiling, in particular hard soiling, from the outside, also cause such damage and failures in the turbochargers. Hard particles such as, for example, soiling, in the lubricant, become embedded in roller bearing faces. The resulting high degree of roughness of rings and roller bearings leads to poor lubrication conditions owing to contact between metal and metal at contact points. The embedded surface unevennesses cut in during the rolling movement, causing spalling and promoting propagation of fractures, which shortens the service life of such damaged bearings.

DE 601 32 814 T2 discloses a roller bearing with an inner ring, an outer ring and roller bodies, the inner ring of which is composed of an M62 steel.

U.S. Pat. No. 6,585,483 B2 discloses a starter for a gas turbine of a mobile unit, such as aircraft, ships or military vehicles. This starter comprises a transmission which has a fixed, mounted shaft. The shaft is fabricated from an M62 steel.

Against this background, the object of the present invention is to provide a bearing for a turbocharger which overcomes the abovementioned disadvantages, can cope with the extraordinarily strict and complex requirements and the complexities involved in the operation of a turbocharger, and is simple in structural terms and cost-effective to manufacture.

This object is achieved according to the invention by means of a ball bearing arrangement for a turbocharger according to the independent patent claim.

This ball bearing arrangement for a turbocharger has a turbocharger shaft, which is to be mounted, and a housing part of the turbocharger, wherein an inner raceway of the ball bearing arrangement is formed on an outer surface of the turbocharger shaft, wherein an outer raceway of the ball bearing arrangement is formed on an inner surface of the housing part, and wherein balls can be inserted between the outer raceway and the inner raceway. According to the invention, the inner raceway and/or the outer raceway are/is fabricated from an M62 steel.

The invention is based on the idea that in particular the wear or the abrasion of raceways in a bearing arrangement in turbochargers owing to the environmental conditions there is the factor which limits the service life. Taking this idea as a starting point, the invention's approach is that it is possible to counteract the environment in a turbocharger, which is heavily loaded, highly aggressive and has a tendency to abrasion, by using an M62 steel.

In particular the high degree of hardness of over 66+ HRC and the high degree of resistance to abrasion and resistance to wear of the M62 steel material make it an extremely advantageous material for such an environment in a turbocharger, particularly for raceways of bearings in turbochargers. In fact, it has surprisingly been found that the use of a material containing a large volume fraction of hard fine carbides, such as M62 steel, combines good wear resistance, toughness, strength and resistance to thermal fatigue and shocks or vibrations, and copes surprisingly well under environmental conditions such as those in turbochargers. A high abrasive wear resistance prevents a high degree of surface roughness and therefore shearing fractures due to contact faces of metal on metal. High local toughness counteracts propagation of fractures.

The service lives of roller bearings which are used in such cases can be increased by means of the invention, and consequently costs can be reduced.

Preferred developments of the invention can be found in the dependent claims.

It is possible to provide that in the case of the ball bearing arrangement the outer raceway and/or the inner raceway are/is subjected to additional hardness treatment and/or surface treatment. Such additional hardness treatment or surface treatment can be nitriding, in particular furnace nitriding, gas nitriding, plasma nitriding or carbonitriding.

In addition there may preferably be provision for the ball bearing arrangement to be provided with a seal for the purpose of forming a seal.

An exemplary embodiment of the invention will be described below with reference to the FIGURE. In the drawing:

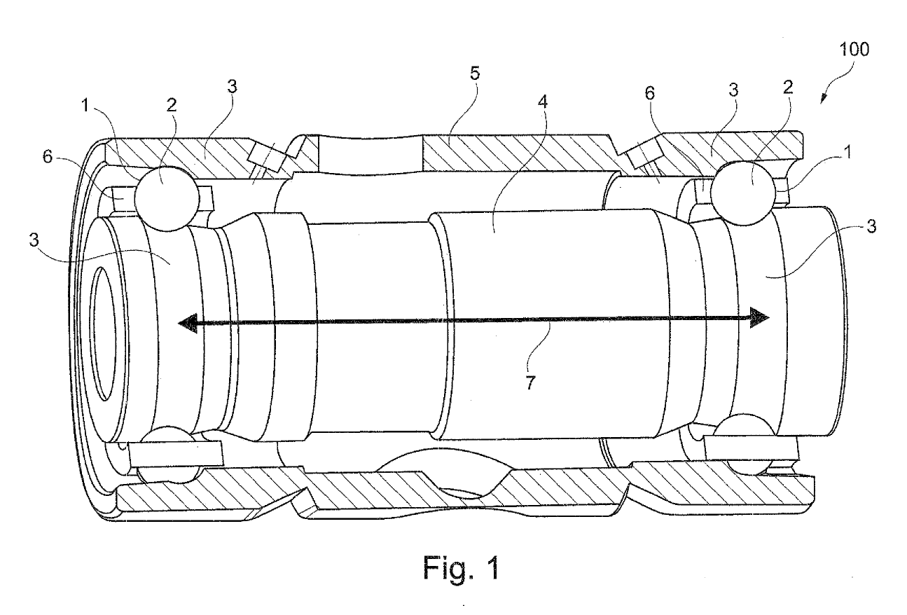

FIG. 1 shows a section of a roller bearing arrangement of a shaft bearing in a turbocharger according to an exemplary embodiment.

### DETAILED DESCRIPTION OF THE DRAWING

FIG. 1 shows a section of a roller bearing arrangement 100 of a shaft bearing in a turbocharger. The turbocharger has a turbine wheel (not illustrated) which drives a compressor wheel (not illustrated) of the turbocharger via a rotatably mounted shaft 4. This shaft 4 which rotates at high speed is mounted by means of two angular ball bearings 1 which are arranged in an O arrangement and which support the shaft 4 with respect to a fixed housing or bearing carrier 5.

Both the inner raceways 3 and the outer raceways 3 of the two angular ball bearings 1 are formed directly in the shaft 4 or in the bearing carrier 5. The roller bodies 2, in this case the balls 2, are arranged in two rows of balls between the respective inner raceway 3 and the associated outer raceway 3 of the two angular ball bearings 1.

In order to keep the balls 2 at a distance, the rows of balls of the two angular ball bearings 1 are each arranged in a solid cage 6, denoted below for short as cage 6.

The inner raceways 3 and the outer raceways of the two angular ball bearings 1 are fabricated from N62 steel.

As is also shown in FIG. 1, changing axial forces 7 occur at the shaft 4, leading to erratic or chaotic movements of the roller bodies and to shock-like loads on the raceways 3.

The high degree of hardness of over 66+ HRC and the high degree of resistance to abrasion, toughness and resistance to wear of the M62 steel material for the raceways 3 make them less sensitive to the complex environmental conditions to which the roller bearing arrangement 100 is subjected in the turbocharger, and as a result increase the service life of the roller bearing arrangement, and respectively of the turbocharger.

### LIST OF REFERENCE SYMBOLS

1 Angular ball bearing
2 Roller body, ball
3 Raceway
4 Shaft
5 Bearing carrier, housing
6 Cage
7 Axial force, direction of axial force (changing)
100 Roller bearing arrangement

1. A ball bearing arrangement for a turbocharger, comprising:
a turbocharger shaft, which is to be mounted; and
a housing part of the turbocharger,
wherein an inner raceway of the ball bearing arrangement is formed on an outer surface of the turbocharger shaft,
wherein an outer raceway of the ball hearing arrangement is formed on an inner surface of the housing part,
wherein balls are inserted between the outer raceway and the inner raceway, and
wherein the inner raceway and/or the outer raceway are/is fabricated from an M62 steel.

2. The ball bearing arrangement according to claim 1, wherein the outer raceway and/or the inner raceway are/is subjected to additional hardening treatment and/or surface treatment.

3. The ball bearing arrangement according to a claim 2, wherein the additional hardening treatment or surface treatment is nitriding.

4. The ball hearing arrangement according to claim 1, wherein a seal is used for sealing the ball bearing arrangement.

5. The ball bearing arrangement according to claim 3, wherein the nitriding can be furnace nitriding, gas nitriding, plasma nitriding or carbonitriding.
